(19) United States
(12) Patent Application Publication
(10) Pub. No.: US 2026/0005962 A1
(43) Pub. Date: Jan. 1, 2026

(54) NETWORK DEVICE USING SOFTWARE FLOW TABLE AND NETWORK PROCESSING UNIT FOR PACKET FORWARDING AND RELATED PACKET FORWARDING METHOD

(71) Applicant: Airoha Technology (Suzhou) Limited, Suzhou City (CN)

(72) Inventors: Weihua Huang, Nanjing City (CN); Fei Yan, Nanjing City (CN)

(73) Assignee: Airoha Technology (Suzhou) Limited, Suzhou City (CN)

(21) Appl. No.: 19/206,031

(22) Filed: May 12, 2025

(30) Foreign Application Priority Data
Jun. 28, 2024 (CN) 202410855728.6

(51) Int. Cl. H04L 45/7453

(52) U.S. Cl. CPC H04L 45/7453

(57) ABSTRACT

A network device includes a storage device, a hardware-accelerated forwarding circuit, and a network processing unit (NPU). The storage device stores a software flow table, where the software flow table includes a plurality of table entries. The hardware-accelerated forwarding circuit receives a first packet from a network, obtains a first hash value of the first packet, and determines that the first hash value encounters a hash collision in a hardware flow table. The NPU receives the first packet from the hardware-accelerated forwarding circuit, and deals with forwarding of the first packet according to forwarding information recorded in a table entry when the first packet hits the table entry of the software flow table.

### BACKGROUND OF THE INVENTION

### 1. Field of the Invention

The present invention relates to network packets forwarding, and more particularly, to a network device and related packet forwarding method that use a central processing unit to establish a software flow table and use a network processing unit to perform fast forwarding for improving packet forwarding efficiency under a condition where a hardware flow table has a hash collision.

### 2. Description of the Prior Art

A gateway is a common network device used to connect different networks and forward packets from one network to another. When packets are forwarded by software running on a central processing unit (CPU) (e.g., forwarded by a network protocol stack of a Linux kernel), forwarding information is generally written into a hardware-accelerated forwarding circuit. Therefore, subsequent packet forwarding can be offloaded from software (i.e., the network protocol stack executed by the CPU) to hardware (i.e., the hardware-accelerated forwarding circuit), thereby improving packet forwarding efficiency.

Generally speaking, the hardware-accelerated forwarding circuit has a hardware flow table, and obtains a corresponding hash value through a keyword in each packet. The hash value is used as an index value. Therefore, the hardware-accelerated forwarding circuit can access a table entry of the hardware flow table according to the hash value. However, in the process of establishing the hardware flow table, the same hash value may be obtained from keywords of different packets, which results in a hash collision in the hardware flow table. The design of the hardware-accelerated forwarding circuit generally allows a certain number of hash collisions. However, when forwarding a large number of packets at the same time, the number of hash collisions may exceed an upper limit allowed by the hardware-accelerated forwarding circuit. At this moment, the packets that cannot be directly forwarded by the hardware-accelerated forwarding circuit due to hash collisions have to be transmitted to the CPU, and the CPU executes software (e.g., the network protocol stack) to perform packet forwarding. This not only occupies a large amount of processor resource, but also reduces the overall packet forwarding efficiency.

### SUMMARY OF THE INVENTION

One of the objectives of the claimed invention is to provide a network device and related packet forwarding method that use a central processing unit to establish a software (SW) flow table and use a network processing unit to perform fast forwarding for improving packet forwarding efficiency under a condition where a hardware (HW) flow table has a hash collision.

According to a first aspect of the present invention, an exemplary network device is disclosed. The exemplary network device includes a storage device, a hardware-accelerated forwarding circuit, and a network processing unit (NPU). The storage device is arranged to store a software flow table, wherein the software flow table includes a plurality of table entries. The hardware-accelerated forwarding circuit is arranged to receive a first packet from a network, obtain a first hash value of the first packet, and determine that the first hash value encounters a hash collision in a hardware flow table. The NPU is arranged to receive the first packet from the hardware-accelerated forwarding circuit, and further arranged to deal with forwarding of the first packet according to forwarding information recorded in a table entry of the software flow table when the first packet hits the table entry of the software flow table.

According to a second aspect of the present invention, an exemplary network device is disclosed. The exemplary network device includes a storage device, a hardware-accelerated forwarding circuit, a network processing unit (NPU), and a central processing unit (CPU). The storage device is arranged to store a software flow table, wherein the software flow table includes a plurality of table entries. The hardware-accelerated forwarding circuit is arranged to receive a packet from a network, obtain a hash value of the packet, and determine that the hash value encounters a hash collision in a hardware flow table. The NPU is arranged to receive the packet from the hardware-accelerated forwarding circuit, determine that the packet does not hit any table entry in the software flow table, and find an available table entry in the software flow table. The CPU is arranged to receive the packet from the NPU, deal with forwarding of the packet, and fill original information and forwarding information corresponding to the packet in the available table entry.

According to a third aspect of the present invention, an exemplary packet forwarding method is disclosed. The exemplary packet forwarding method includes: storing a software flow table in a storage device, wherein the software flow table comprises a plurality of table entries; receiving a packet from a network, and obtaining a hash value of the packet; in response to the hash value encountering a hash collision in a hardware flow table of a hardware-accelerated forwarding circuit, transmitting the packet from the hardware-accelerated forwarding circuit to a network processing unit (NPU); when the packet hits a table entry in the software flow table, using the NPU to deal with forwarding of the packet according to forwarding information recorded in the table entry; and when the packet does not hit any table entry in the software flow table, transmitting the packet from the NPU to a central processing unit (CPU), using the CPU to deal with forwarding of the packet, and filling original information and forwarding information corresponding to the packet in an available table entry of the software flow table.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a network device according to an embodiment of the present invention.

FIG. 2 is a flowchart illustrating a packet forwarding method of using a central processing unit to establish a software flow table and using a network processing unit to perform fast forwarding for improving packet forwarding efficiency under a condition where a hardware flow table has a hash collision according to an embodiment of the present invention.

FIG. 3 is a flowchart illustrating an operation of the NPU shown in FIG. 1 that operates under a condition where a hardware flow table has a hash collision.

FIG. 4 is a flowchart illustrating an operation of the CPU shown in FIG. 1 that operates under a condition where a hardware flow table has a hash collision.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

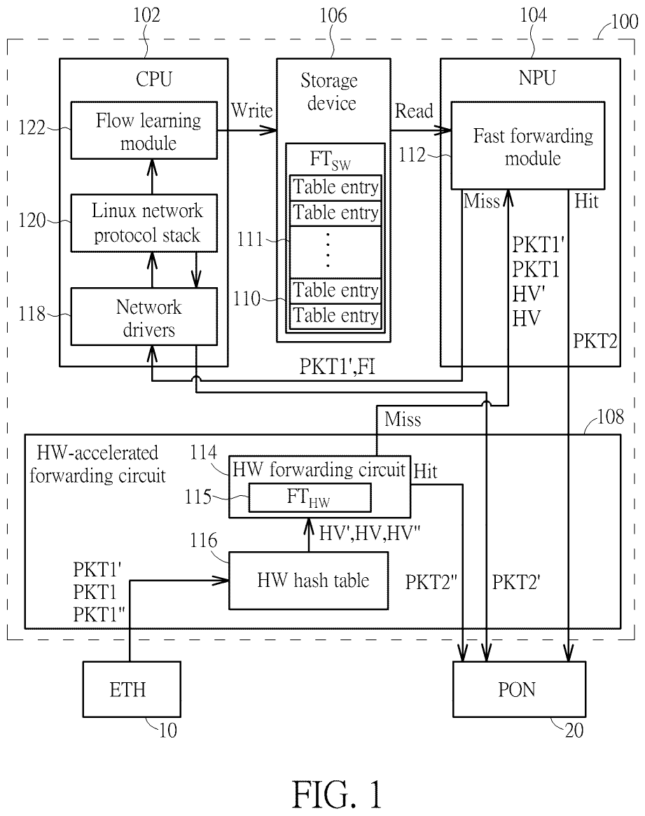

FIG. 1 is a diagram illustrating a network device according to an embodiment of the present invention. For example, the network device 100 may be a gateway used for connecting different networks (e.g., Ethernet (ETH) 10 and Passive Optical Network (PON) 20). In this embodiment, the network device 100 includes a central processing unit (CPU) 102, a network processing unit (NPU) 104, a storage device 106, and a hardware-accelerated forwarding circuit 108. Please note that only the components pertinent to the present invention are illustrated in FIG. 1. In practice, the network device 100 may include other components to achieve designated network functions.

The CPU 102 may be implemented by a general-purpose processor, and may load and execute a plurality of software modules, including network drivers 118, a Linux network protocol stack 120, and a flow learning module 122. When a packet needs to be forwarded by the CPU 102, the packet is received through a network driver 118 of the Ethernet 10 and then provided to the Linux network protocol stack 120 for packet forwarding processing, and a to-be-forwarded packet that is generated from the Linux network protocol stack 120 is transmitted through a network driver 118 of the PON 20.

The NPU 104 may be implemented by an application specific integrated circuit (ASIC) optimized for network applications, and may execute a fast forwarding module 112 to assist in packet forwarding. In other words, the NPU 104 is equipped with a packet forwarding function. Hence, a packet forwarding task of the CPU 102 can be offloaded to the NPU 104 for improving the packet forwarding efficiency.

The storage device 106 may be implemented as a dynamic random access memory (DRAM), and is used to store a software flow table (labeled by “FT_{SW}”) 110. For example, the storage device 106 may have a storage space that is allocated to the software flow table 110, and may divide the storage space into a plurality of storage units, each of which is used to store a table entry 111 of the software flow table 110. For example, each table entry 111 may record a plurality of fields, including a state field, a pkt type field, a time stamp field, an ipv4_info field, and an ipv6_info field. The state field is used to indicate a use status of the table entry. When the state field indicates “unbind”, it means that the table entry is not used yet and records an initial value filled in by initialization when it is first created. When the state field indicates “bind”, it means that the table entry is used and stores related information of a packet that has been forwarded before. The pkt_type field is used to indicate whether the packet to be forwarded is an IPv4 packet or an IPv6 packet. The time_stamp field is used to indicate a time stamp of this table entry most recently read for packet forwarding. Therefore, by comparing the current time with the time recorded in the time_stamp field, it can be determined whether this table entry has been idle for a period exceeding an idle timeout period (i.e., whether an elapsed time from the time recorded in the time_stamp field to the current time exceeds a threshold) and can be considered invalid. The ipv4_info field is used to record the IPv4 packet's original information (e.g., header information of the original IPv4 packet) and forwarding information (e.g., header information of the forwarded IPV4 packet). The ipv6_info field is used to record the IPV6 packet's original information (e.g., header information of the original IPV6 packet) and forwarding information (e.g., header information of the forwarded IPv6 packet).

The hardware-accelerated forwarding circuit 108 acts as a frame engine to provide a hardware acceleration function for reducing the workload of the CPU 102 and accelerating the packet forwarding. The hardware-accelerated forwarding circuit 108 may include a hardware forwarding circuit 114 and a hardware hash table 116, wherein the hardware forwarding circuit 114 has a hardware flow table (labeled by “FT_{HW}”) 115. The hardware hash table 116 may store a plurality of pre-calculated hash values, and may search for a table entry through a keyword of a packet and output a corresponding hash value of the packet. However, this is for illustrative purposes only. The present invention has no limitations on means of generating hash values. For example, in other embodiments, the hash value may be directly calculated and generated through a hash function. The hardware forwarding circuit 114 is equipped with a packet forwarding function. Hence, the packet forwarding task of the CPU 102 can be offloaded to the hardware forwarding circuit 114 for improving the packet forwarding efficiency.

The design of the hardware-accelerated forwarding circuit 108 tolerates a certain number of hash collisions. However, when forwarding a large number of packets at the same time, the number of hash collisions will exceed the upper limit tolerated by the hardware-accelerated forwarding circuit 108. If the packets are transmitted to the CPU for forwarding, a large amount of processor resource will be occupied and the overall packet forwarding efficiency will be reduced. To address this issue, the present invention proposes using the CPU 102 to establish a software flow table 111 and using the NPU 104 to perform fast forwarding, which improves the packet forwarding efficiency under a condition where the hardware flow table has hash collisions. More specifically, the software flow table 110 disclosed in the present invention can be considered an expansion of the hardware flow table 115. When the hardware forwarding circuit 114 cannot use the hardware flow table 115 for packet forwarding due to hash collisions, the NPU 104 and the software flow table 110 can be used to achieve fast forwarding.

In an operation example, the hardware-accelerated forwarding circuit 108 receives a packet PKT1″ from the Ethernet 10, and obtains a hash value HV″ of the packet PKT1″ through the hardware hash table 116. In addition, the hardware flow table 115 includes a plurality of table entries indexed by different hash values, respectively. Therefore, the hardware forwarding circuit 114 refers to the hash value HV″ to read a corresponding table entry in the hardware flow table 115. If the original information recorded in the table entry corresponding to the hash value HV″ can match the information carried by the packet PKT1″, the hardware forwarding circuit 114 determines that the packet PKT1″ hits the table entry in the hardware flow table 115. Therefore, the hardware forwarding circuit 114 modifies the packet PKT1″ according to the forwarding information recorded in the table entry corresponding to the hash value HV″, to generate a modified packet PKT2″ (i.e., a packet to be forwarded), and directly forwards the modified packet PKT2″ to the PON 20 without intervention of the CPU 102.

In another operation example, the hardware-accelerated forwarding circuit 108 receives a packet PKT1 from the Ethernet 10, and obtains a hash value HV of the packet PKT1 through the hardware hash table 116. In addition, the hardware forwarding circuit 114 refers to the hash value HV to read a corresponding table entry in the hardware flow table 115. If the original information recorded in the table entry corresponding to the hash value HV cannot match the information carried by the packet PKT1, the hardware forwarding circuit 114 determines that the hash value HV of the packet PKT1 encounters a hash collision in the hardware flow table 115 (i.e., the table entry corresponding to the hash value HV records the forwarding information of other data flow), and transmits the packet PKT1 and the hash value HV to the NPU 104. Since the NPU 104 directly uses the hash value HV already obtained by the hardware-accelerated forwarding circuit 108, the hash value processing/calculation time can be saved, thereby improving the packet forwarding efficiency. However, this is for illustrative purposes only, and is not meant to be a limitation of the present invention.

The fast forwarding module 112 in the NPU 104 refers to the hash value (e. g., the hash value HV provided by the hardware-accelerated forwarding circuit 108) to read the corresponding table entry in the software flow table 110. If the original information recorded in the table entry corresponding to the hash value HV matches the information carried by the packet PKT1, the fast forwarding module 112 determines that the packet PKT1 hits the table entry in the software flow table 110. Therefore, the fast forwarding module 112 modifies the packet PKT1 according to the forwarding information recorded in the table entry corresponding to the hash value HV, to generate a modified packet PKT2 (i.e., a packet to be forwarded), and directly forwards the modified packet PKT2 to the PON 20 without intervention of the CPU 102.

The forwarding information recorded in the software flow table 110 is obtained by the flow learning module 122 according to to-be-forwarded packets that are generated during a period in which the CPU 102 executes the software (e.g., the Linux network protocol stack 120) to deal with the packet forwarding. For example, the hardware-accelerated forwarding circuit 108 receives a packet PKT1′ from the Ethernet 10, and obtains a hash value HV′ of the packet PKT1′ through the hardware hash table 116. In addition, the hardware forwarding circuit 114 refers to the hash value HV′ to read a corresponding table entry in the hardware flow table 115. If the original information recorded in the table entry corresponding to the hash value HV′ does not match the information carried by the packet PKT1′, the hardware forwarding circuit 114 determines that the hash value HV′ of the packet PKT1′ encounters a hash collision in the hardware flow table 115 (i.e., the table entry corresponding to the hash value HV′ records the forwarding information of other data flow), and transmits the packet PKT1′ and the hash value HV′ to the NPU 104. Since the NPU 104 directly uses the hash value HV′ already obtained by the hardware-accelerated forwarding circuit 108, the hash value processing time can be saved, thereby improving the packet forwarding efficiency. However, this is for illustrative purposes only, and is not meant to be a limitation of the present invention.

The fast forwarding module 112 in the NPU 104 refers to the hash value HV′ to read the corresponding table entry in the software flow table 110. If the table entry corresponding to the hash value HV′ is an unused table entry, the fast forwarding module 112 directly determines that the packet PKT1′ cannot hit any table entry in the software flow table 110, and transmits the packet PKT1′ to the CPU 102 for forwarding. If the table entry corresponding to the hash value HV′ is a used table entry that has not been idle for a period exceeding an idle timeout period (i.e., a used table entry that does not have an idle timeout), and the recorded original information does not match the information carried by the packet PKT1′, the fast forwarding module 112 determines that the hash value HV′ of the packet PKT1′ encounters a hash collision in the software flow table 110 (i.e., the table entry corresponding to the hash value HV′ records the forwarding information of other data flow). At this moment, the fast forwarding module 112 enables a processing procedure of the hash collision. If the fast forwarding module 112 still determines that the packet PKT1′ cannot hit any table entry in the software flow table 110 during the processing procedure of the hash collision, the fast forwarding module 112 transmits the packet PKT1′ to the CPU 102 for forwarding. Since both of the NPU 104 and the hardware-accelerated forwarding circuit 108 are unable to deal with forwarding of the packet PKT1′, the CPU 102 needs to intervene in forwarding of the packet PKT1′. If the NPU 104 can find an available table entry in the software flow table 110, the NPU 104 further provides an index value FI of the available table entry in the software flow table 110 to the CPU 102 (particularly, the flow learning module 122 executed by the CPU 102). In addition to the Linux network protocol stack 120 that processes the packet PKT1′ to generate the modified packet PKT2 (i.e., a packet to be forwarded), the CPU 102 executes the flow learning module 122 to parse the packet to be forwarded, and refers to the index value FI to write the forwarding information into the available table entry in the software flow table 110. Finally, the CPU 102 forwards the packet PKT2 to the PON 20.

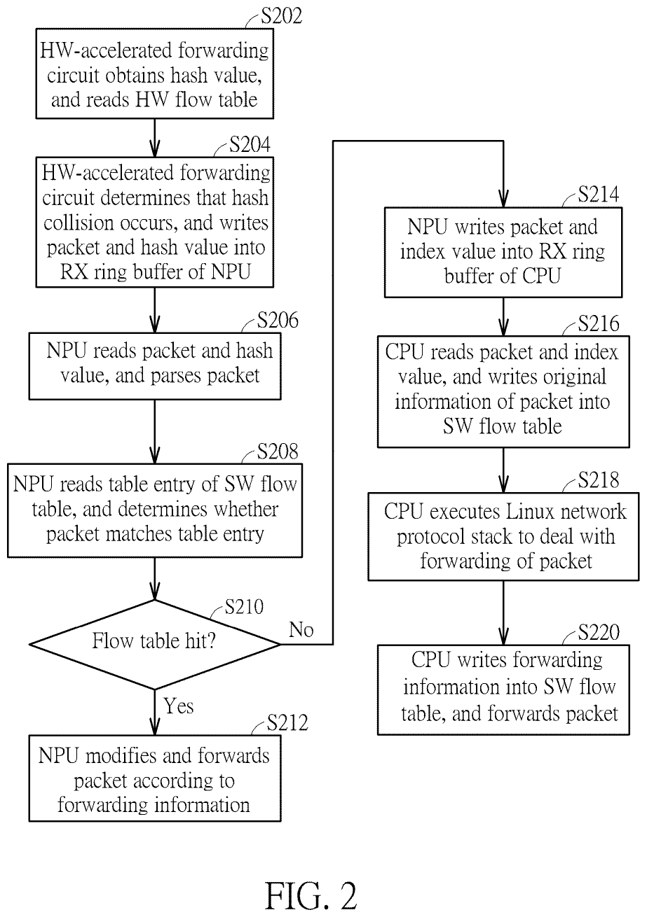

FIG. 2 is a flowchart illustrating a packet forwarding method of using the CPU 102 to establish the software flow table 111 and using the NPU 104 to perform fast forwarding for improving packet forwarding efficiency under a condition where a hardware flow table has a hash collision according to an embodiment of the present invention. Provided that the result is substantially the same, the steps of the packet forwarding method of the present invention are not required to be executed in the exact order shown in FIG. 2. In step S202, the hardware-accelerated forwarding circuit 108 receives a packet PKT (e.g., PKT=PKT1/PKT1′) from the Ethernet 10, obtains a hash value Hash_index of the packet PKT (e.g., Hash_index=HV/HV′) through the hardware hash table 116, and reads a table entry in the hardware flow table 115 through the hash value Hash_index. In step S204, the hardware-accelerated forwarding circuit 108 determines that the hash value Hash_index of the packet PKT encounters a hash collision in the hardware flow table 115, and therefore writes the packet PKT and the hash value Hash_index to the receive (RX) ring buffer of the NPU 104. In step S206, the NPU 104 reads the packet PKT and the hash value Hash_index from the RX ring buffer, and parses the packet PKT (particularly, the header of the packet PKT). In step S208, the NPU 104 reads a table entry in the software flow table 110 according to the hash value Hash_index, and determines whether the table entry in the software flow table 110 matches the packet PKT (i.e., whether the packet PKT hits the table entry corresponding to the hash value Hash_index) according to the packet information (particularly, packet header information) obtained by parsing the packet PKT. If the packet PKT (e.g., PKT=PKT1) hits the table entry corresponding to the hash value Hash_index (step S210), the NPU 104 modifies the packet PKT according to the forwarding information recorded in the matched table entry, and forwards the modified packet (e.g., PKT 2) (step S212).

If the packet PKT (e.g., PKT=PKT1′) does not hit the table entry corresponding to the hash value Hash_index (step S210), the NPU 104 writes the packet PKT and the index value flow_index (e.g., flow_index=FI) into the RX ring buffer of the CPU 102 (step S214). In step S216, the CPU 102 reads the packet PKT (e.g., PKT=PKT1′) and the index value flow_index (e.g., flow_index=FI) from the RX ring buffer, and writes the original information (e.g., header information of the packet PKT) obtained by parsing the packet PKT into a table entry in the software flow table 110 that corresponds to the index value flow_index. In step S218, the CPU 102 executes the Linux network protocol stack 120 to deal with forwarding of the packet PKT (e.g., PKT=PKT1′), and generates a modified packet (e. g., PKT 2′ which is a packet to be forwarded). In step S220, the CPU 102 executes the flow learning module 122 to parse the packet to be forwarded (e. g., PKT 2′), and fills the parsed forwarding information (e.g., header information of the packet PKT 2′) in the table entry corresponding to the same index value flow_index. Finally, the CPU 102 forwards the packet (e.g., PKT 2′) to the PON 20.

FIG. 2 is merely used to provide a simple description of the inventive concept of the packet forwarding method of the present invention. The operations of the flow learning module 122 of the CPU 102 and the fast forwarding module 112 of the NPU 104 are described in detail as below, with reference to the accompanying drawings.

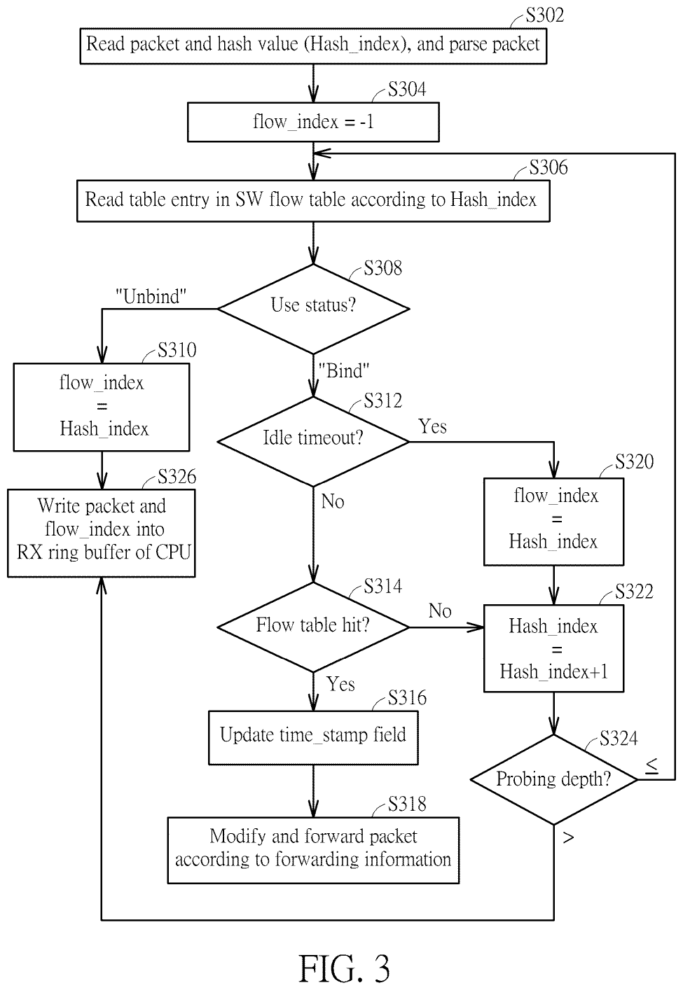

FIG. 3 is a flowchart illustrating an operation of the NPU 104 shown in FIG. 1 that operates under a condition where a hardware flow table has a hash collision. If the result is substantially the same, the steps are not required to be executed in the exact order shown in FIG. 3. In step S302, the NPU 104 reads the packet PKT and the hash value Hash_index. In step S304, the NPU 104 sets the index value flow_index by an initial value (e.g., flow_index=−1). In this embodiment, the index value flow_index is used to indicate whether there is an available table entry (e.g., an unused table entry, or a table entry that is used and has been idle for a period exceeding an idle timeout period, that is, a used table entry that has an idle timeout) in the software flow table 110 and a location of the available table entry in the software flow table 110. For example, if the index value flow_index is not equal to the initial value, it means that there is an available table entry in the software flow table 110, and the index value flow_index itself can also be used as a hash value to access the available table entry in the software flow table 110.

In step S306, the NPU 104 reads the table entry in the software flow table 110 according to the hash value Hash_index. In step S308, the NPU 104 checks the state field recorded in the table entry read from the software flow table 110. If the state field indicates “unbind”, this means that this table entry is not used and records the initial value that is set by initialization when the table entry is first established. This also implies that the packet PKT cannot hit any table entry in the software flow table 110, such that the subsequent process enters step S310 to update the index value flow_index from the initial value (e.g., flow_index=−1) to the hash value Hash_index (i.e., flow_index=Hash_index). Next, in step S326, the NPU 104 writes the packet PKT and the final index value flow_index (i.e., flow_index=Hash_index) to the RX ring buffer of the CPU 102.

If the state field checked by the NPU 104 in step S308 indicates “bind”, this means that this table entry is used. In other words, the CPU 102 has previously dealt with forwarding of another packet, and the final index value flow_index of the another packet has the same value as the hash value Hash_index of the current packet PKT. That is, based on the index value flow_index of the another packet, the flow learning module 122 has previously written the original information and forwarding information corresponding to the another packet into the table entry that is also indexed by the hash value Hash_index of the current packet PKT. In step S312, the NPU 104 reads the time_stamp field of this table entry to determine whether this table entry has been idle for a period exceeding an idle timeout period and can be considered invalid. If this table entry has not been idle for a period exceeding an idle timeout period, the NPU 104 checks whether the information carried by the packet PKT matches the original information (e.g., header information) of the previously forwarded packet recorded in this table entry (step S314). If both match, the NPU 104 determines that the packet PKT hits this table entry. Hence, the NPU 104 uses the current time to update the time_stamp field of this table entry (step S316), and modifies the packet PKT according to the forwarding information of the previously forwarded packet that is recorded in this table entry and forwards the modified packet (step S318).

If the NPU 104 determines that this table entry has been idle for a period exceeding an idle timeout period and can be considered invalid (step S312), this means that this table entry can be selected as an available table entry in the software flow table 110. Hence, the subsequent process enters step S320 to update the index value flow_index from the initial value (e.g., flow_index=−1) to the hash value Hash_index (i.e., flow_index=Hash_index).

On the other hand, when the NPU 104 determines that this table entry has been idle for a period exceeding an idle timeout period and can be considered invalid (step S312), this implies that the packet PKT does not hit this table entry. Since the state field checked in step S308 indicates “bind”, this means that this table entry has been used, so the hash value Hash_index encounters a hash collision in the software flow table 110; similarly, when the NPU 104 determines that the packet PKT does not hit this table entry (step S314), since the state field checked in step S308 indicates “bind”, this means that this table entry has been used, so the hash value Hash_index encounters a hash collision in the software flow table 110. In a case where a hash collision occurs in the software flow table 110, the NPU 104 enables a processing procedure of the hash collision. In this embodiment, the NPU 104 may use open addressing to probe the software flow table 110 for an available table entry (e.g., an unused table entry, or a table entry that is used and has been idle for a period exceeding an idle timeout period, that is, a used table entry that has an idle timeout) or a table entry that can be hit by the packet PKT. For example, within a range of a probing depth DEP, the NPU 104 may use linear probing to search for an available table entry (e.g., an unused table entry, or a table entry that is used and has been idle for a period exceeding an idle timeout period, that is, a used table entry that has an idle timeout) or a table entry that can be hit by the packet PKT. In step S322, the hash value Hash_index is updated to the next hash value (i.e., Hash_index=Hash_index+1). In step S324, the NPU 104 determines whether the current hash value Hash_index exceeds the probing depth DEP. If the current hash value Hash_index exceeds the probing depth DEP, it means that the processing procedure of the hash collision has been completed. If a table entry that is used and has been idle for a period exceeding an idle timeout period (i.e., a used table entry that has an idle timeout) is found in the processing procedure of the hash collision (i.e., step S320 has been executed at least once), the index value flow_index records the corresponding hash value Hash_index of the table entry that is used and has been idle for a period exceeding an idle timeout period. However, if no table entry that is used and has been idle for a period exceeding an idle timeout period can be found in the processing procedure of the hash collision (i.e., step S320 is not executed yet), the index value flow_index still maintains the initial value (e.g., flow_index=−1). In step S326, the NPU 104 writes the packet PKT and the index value flow_index (e.g., flow_index=−1 (step S304) or flow_index=Hash_index (step S320)) into the RX ring buffer of the CPU 102. If the NPU 104 determines that the current hash value Hash_index does not exceed the probing depth DEP (step S324), the process returns to step S306 to continue the probing. Please note that, if a table entry that can be hit by the packet PKT is found in the processing procedure of the hash collision (step S314), the packet forwarding (steps S316 and S318) is directly executed without enabling the subsequent flow learning operation.

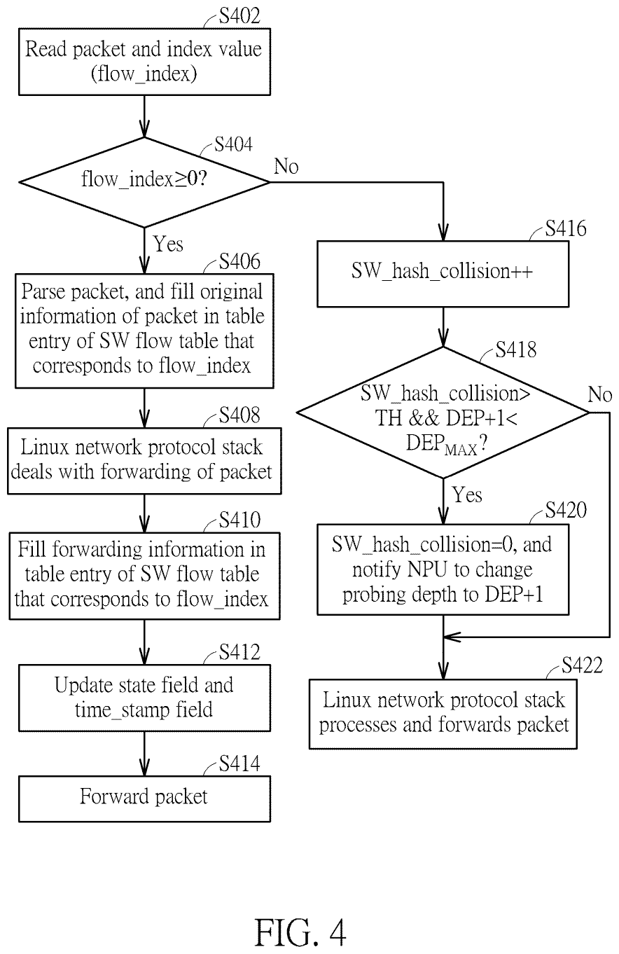

FIG. 4 is a flowchart illustrating an operation of the CPU 102 shown in FIG. 1 that operates under a condition where a hardware flow table has a hash collision. If the result is substantially the same, the steps are not required to be executed in the exact order shown in FIG. 4. In step S402, the CPU 102 reads the packet PKT (e.g., PKT=PKT1′) and the index value flow_index. In step S404, the CPU 102 determines whether the index value flow_index is not the initial value (e.g., −1). If the index value flow_index is not the initial value (e.g., flow_index≥0), it means that the NPU 104 finds an available table entry (e.g., an unused table entry, or a table entry that is used and has been idle for a period exceeding an idle timeout period, that is, a used table entry that has an idle timeout) in the software flow table 110. Hence, the process enters step S406. In step S406, the CPU 102 parses the packet PKT and writes the original information of the packet PKT into the table entry in the software flow table 110 that corresponds to the index value flow_index. In step S408, the CPU 102 executes the Linux network protocol stack 120 to deal with forwarding of the packet PKT and generate a modified packet (e.g., the packet PKT2′ to be forwarded). In step S410, the CPU 102 parses the packet to be forwarded (e.g., PKT2′) and writes the forwarding information into the table entry in the software flow table 110 that corresponds to the same index value flow_index. Since the table entry corresponding to the index value flow_index is used, the CPU 102 sets the state field to “bind” in step S412. In addition, since the table entry corresponding to the index value flow_index is currently used for packet forwarding, the CPU 102 sets a timestamp recorded in the time_stamp field (i.e., a timestamp when this table entry was most recently read for packet forwarding) by the current time in step S412. In step S414, the CPU 102 transmits the packet to be forwarded (e.g., PKT2′) to the PON 20.

If the CPU 102 determines that the index value flow_index still maintains the initial value (e.g., flow_index=−1) (step S404), it means that the NPU 104 fails to find an available table entry (e.g., an unused table entry, or a table entry that is used and has been idle for a period exceeding an idle timeout period, that is, a used table entry that has an idle timeout) within the range of the probing depth DEP in the software flow table 110. Therefore, the process enters step S416. In step S416, the CPU 102 updates the current hash collision count value SW_hash_collision (i.e., SW_hash_collision=SW_hash_collision+1). In step S418, the CPU 102 checks one or more judgment conditions to determine whether it is necessary to dynamically adjust the current probing depth DEP. For example, the CPU 102 determines whether the hash collision count value SW_hash_collision exceeds a threshold TH, and/or determines whether an increased probing depth (e.g., DEP+1) does not reach an allowed predetermined maximum value DEP_{MAX}. In this embodiment, when the judgment conditions SW_hash_collision>TH and DEP+1 <DEP_{MAX} are satisfied, the CPU 102 executes step S420 to notify the NPU 104 to use the increased probing depth (e.g., DEP+1). In addition, the CPU 102 resets the hash collision count value SW_hash_collision to an initial value (e.g., SW_hash_collision=0). In step S422, the CPU 102 executes the Linux network protocol stack 120 to process the packet PKT to generate a modified packet (e.g., the packet PKT2′ to be forwarded), and forwards the modified packet (e.g., the packet PKT2′ to be forwarded) to the PON 20.

Please note that, in addition to dynamically increasing the probing depth DEP according to the judgment conditions (e.g., SW_hash_collision>TH and DEP+1 <DEP_{MAX}), the CPU 102 may further check other judgment conditions to determine whether to restore the probing depth DEP to the initial value. In some embodiments of the present invention, the CPU 102 may periodically check the number of table entries in the software flow table 110 that are used but have not been idle for a period exceeding an idle timeout period (i.e., used table entries in the software flow table 110 that do not have idle timeout yet), and determine whether to restore the current probing depth DEP to the initial value according to the number. For example, when the number is smaller than a predetermined percentage of the total number of table entries in the software flow table 110, the CPU 102 restores the current probing depth DEP to the initial value.

When a large number of packets cause a hash collision in the hardware flow table 115, the utilization rate of the CPU 102 increases temporarily to deal with packet forwarding and establish the software flow table 110. Once learning of the software flow table 110 is completed, the NPU 104 can use the software flow table 110 to assist in packet forwarding, such that the utilization rate of the CPU 102 quickly decreases. Compared to using the CPU to process all packets in a case where a hardware flow table has a hash collision, the present invention first uses the CPU to establish the software flow table and then uses the NPU to deal with fast forwarding of packets, which does not occupy too much processor resource and can have better packet forwarding efficiency.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A network device comprising:
a storage device, arranged to store a software flow table, wherein the software flow table comprises a plurality of table entries;
a hardware-accelerated forwarding circuit, arranged to receive a first packet from a network, obtain a first hash value of the first packet, and determine that the first hash value encounters a hash collision in a hardware flow table; and
a network processing unit (NPU), arranged to receive the first packet from the hardware-accelerated forwarding circuit, and further arranged to deal with forwarding of the first packet according to forwarding information recorded in a table entry of the software flow table when the first packet hits the table entry of the software flow table.

2. The network device of claim 1, wherein the NPU is further arranged to receive the first hash value from the hardware-accelerated forwarding circuit, and access the software flow table according to the first hash value.

3. The network device of claim 1, wherein the NPU is further arranged to perform linear probing upon the software flow table; and the first packet hits the table entry of the software flow table before a probing depth of the linear probing is exceeded.

4. The network device of claim 1, wherein the hardware-accelerated forwarding circuit is further arranged to receive a second packet from the network, obtain a second hash value of the second packet, and determine that the second hash value encounters a hash collision in the hardware flow table; the NPU is further arranged to receive the second packet from the hardware-accelerated forwarding circuit, and determine that the second packet does not hit any table entry of the software flow table; and the network device further comprises:
a central processing unit (CPU), arranged to receive the second packet from the NPU, and deal with forwarding of the second packet.

5. The network device of claim 4, wherein the NPU is further arranged to find an available table entry in the software flow table, and the CPU is further arranged to fill original information and forwarding information corresponding to the second packet in the available table entry.

6. The network device of claim 5, wherein the NPU is further arranged to perform linear probing upon the software flow table; and the NPU finds the available table entry in the software flow table before a probing depth of the linear probing is exceeded.

7. The network device of claim 5, wherein the available table entry is an unused table entry of the software flow table.

8. The network device of claim 5, wherein the available table entry is a table entry of the software flow table that is used and has been idle for a period exceeding an idle timeout period.

9. The network device of claim 4, wherein the NPU is further arranged to perform linear probing upon the software flow table; the NPU does not find any available table entry in the software flow table before a probing depth of the linear probing is exceeded; and the CPU is further arranged to update a hash collision count value, and refer to at least the hash collision count value to determine whether to increase the probing depth.

10. The network device of claim 9, wherein when the hash collision count value exceeds a threshold and an increased probing depth does not reach a predetermined maximum value, the CPU notifies the NPU to use the increased probing depth.

11. The network device of claim 9, wherein the CPU is further arranged to periodically check a number of table entries in the software flow table that are used but have not been idle for a period exceeding an idle timeout period, and refer to the number to determine whether to restore the probing depth to an initial value.

12. The network device of claim 11, wherein when the number is smaller than a predetermined percentage of a total number of table entries in the software flow table, the CPU restores the probing depth to the initial value.

13. A network device comprising:
a storage device, arranged to store a software flow table, wherein the software flow table comprises a plurality of table entries;
a hardware-accelerated forwarding circuit, arranged to receive a packet from a network, obtain a hash value of the packet, and determine that the hash value encounters a hash collision in a hardware flow table;
a network processing unit (NPU), arranged to receive the packet from the hardware-accelerated forwarding circuit, determine that the packet does not hit any table entry in the software flow table, and find an available table entry in the software flow table; and
a central processing unit (CPU), arranged to receive the packet from the NPU, deal with forwarding of the packet, and fill original information and forwarding information corresponding to the packet in the available table entry.

14. The network device of claim 13, wherein the NPU is further arranged to receive the hash value from the hardware-accelerated forwarding circuit, and refer to the hash value to access the software flow table.

15. The network device of claim 13, wherein the NPU is further arranged to perform linear probing upon the software flow table; and the NPU finds the available table entry in the software flow table before a probing depth of the linear probing is exceeded.

16. The network device of claim 13, wherein the available table entry is an unused table entry of the software flow table.

17. The network device of claim 13, wherein the available table entry is a table entry of the software flow table that is used and has been idle for a period exceeding an idle timeout period.

18. A packet forwarding method comprising:
storing a software flow table in a storage device, wherein the software flow table comprises a plurality of table entries;
receiving a packet from a network, and obtaining a hash value of the packet;
in response to the hash value encountering a hash collision in a hardware flow table of a hardware-accelerated forwarding circuit, transmitting the packet from the hardware-accelerated forwarding circuit to a network processing unit (NPU);
when the packet hits a table entry in the software flow table, using the NPU to deal with forwarding of the packet according to forwarding information recorded in the table entry; and
when the packet does not hit any table entry in the software flow table, transmitting the packet from the NPU to a central processing unit (CPU), using the CPU to deal with forwarding of the packet, and filling original information and forwarding information corresponding to the packet in an available table entry of the software flow table.
